(19) United States
(12) Patent Application Publication
(10) Pub. No.: US 2001/0012174 A1
(43) Pub. Date: Aug. 9, 2001

(54) RECORDING DISK APPARTUS

(75) Inventor: JUNKO IMAMURA, KAWASAKI-SHI (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/158,211

(22) Filed: Sep. 22, 1998

(30) Foreign Application Priority Data
Apr. 24, 1998 (JP) 10-114515

(51) Int. Cl. G11B 17/02

(52) U.S. Cl. 360/97.01

(57) ABSTRACT

A housing of a recording disk apparatus is provided with a displacement suppression piece opposed to the recording disk within the housing. When the recording disk apparatus is subjected to an impact, the displacement of the recording disk can be suppressed by contact with the displacement suppression piece. The deformation of the disk can be suppressed. Therefore, damage to the head or disk face can be avoided.

### BACKGROUND OF THE INVENTION

1. Field of the Invention

The present invention generally relates to a recording disk apparatus comprising a recording disk with a data area for recording data, and a head for writing and reading data in and out of the data area on the recording disk.

Such recording disk apparatus may be represented by a magnetic disk drive unit such as a hard disk drive unit (HDD).

2. Description of the Prior Art

A magnetic head in operation is in general opposed to a magnetic disk rotating about the rotation axis in an HDD. The magnetic head is supported via a suspension such as a plate spring on the tip end of a carriage arm which is allowed to swing about the swinging axis.

When the HDD is subjected to an impact, the magnetic disk inside the HDD sometimes deforms or vibrates. The displacement of the magnetic disk is usually transmitted to the magnetic disk seated on the surface of the magnetic disk, which happens to damage the suspension.

If such displacement gets larger, the carriage arm of higher rigidity possibly interferes at its tip end with the surface of the magnetic disk. This interference may cause a damage on the data area on the magnetic disk. Such damage on the suspension or data area may hinder the writing and reading operation of the magnetic head.

### SUMMARY OF THE INVENITON

It is accordingly an object of the present invention to provide a recording disk apparatus of higher shock resistance.

According to the present invention, there is provided a recording disk apparatus comprising a displacement suppression piece opposed to a recording disk with a predetermined gap.

When the recording disk apparatus is subjected to an impact, the recording disk interferes with the displacement suppression piece, so that the displacement of the recording disk may be suppressed within the displacement corresponding to the extent of the gap. Therefore, less displacement serves to avoid damages to a head opposed to the recording disk in the recording disk apparatus and/or a disk face of the recording disk.

The displacement suppression piece is preferably opposed to a peripheral margin on the recording disk. When the recording disk apparatus is subjected to an impact, the displacement suppression piece contacts the peripheral margin where no data is recorded. Accordingly, data on the data area of the recording disk can be prevented from damages.

The displacement suppression piece may be integrally formed on a housing which accommodates at least the recording disk. Otherwise, the displacement suppression piece may be formed independent of the housing, so that the displacement suppression piece can be fixed on the housing. In the latter case, it is possible to utilize an elastic material, which cannot be employed for the housing, for the displacement suppression piece. The elasticity of the displacement suppression piece is supposed to absorb the impact upon interference of the recording disk with the displacement suppression piece.

In addition, the displacement suppression piece may be assembled in an actuator mechanism for driving a head opposed to the recording disk. In general, relative position of the actuator mechanism and the recording disk is kept fixed so as to assemble the actuator mechanism and the recording disk into the housing at the same time in assembling the recording disk apparatus. Therefore, the assembly of the displacement suppression piece and the actuator mechanism serves to omit a positioning mechanism specific to the displacement suppression piece. In this case, the actuator mechanism may include a carriage arm capable of swinging a head opposed to the recording disk, a displacement suppression piece attached to the carriage arm so as to face the recording disk with a gap.

Any of the displacement suppression pieces is preferably opposed to a peripheral surface of the recording disk, because the recording disk is displaced larger at the periphery of the recording disk. The recording disk is supposed to bend at a fulcrum at the inner end where the recording disk is coupled to the rotation axis, so that the deformation is expected to cause more displacement toward the outer periphery of the recording disk.

The recording disk apparatus may be employed in a desktop computer system such as a workstation or a personal computer, in a mobile notebook computer, a portable computer, or the like.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 schematically illustrates a hard disk drive unit (HDD) incorporated in a computer system;

FIG. 2 is a perspective view illustrating an HDD according to a first embodiment of the present invention;

FIG. 3 is a plan view illustrating the inner structure of the HDD;

FIG. 4 is a partial enlarged sectional view taken along the line 4-4 in FIG. 3;

FIG. 5 is a partial enlarged sectional view illustrating an example of the displacement suppression piece.

FIG. 6 is a partial enlarged sectional view illustrating another example of the displacement suppression piece;

FIG. 7 is a perspective view illustrating an HDD according to a second embodiment of the present invention;

FIG. 8 is a plan view illustrating the inner structure of the HDD;

FIG. 9 is a partial enlarged sectional view taken along the line 9-9 in FIG. 8;

FIG. 10 is a sectional view illustrating an actuator mechanism provided with the displacement suppression pieces each with a groove of triangular section; and

FIG. 11 is a sectional view illustrating an actuator mechanism provided with the displacement suppression pieces each with a groove of rectangular section.

### DESCRIPTION OF THE PREFERRED EMBODIMENTS

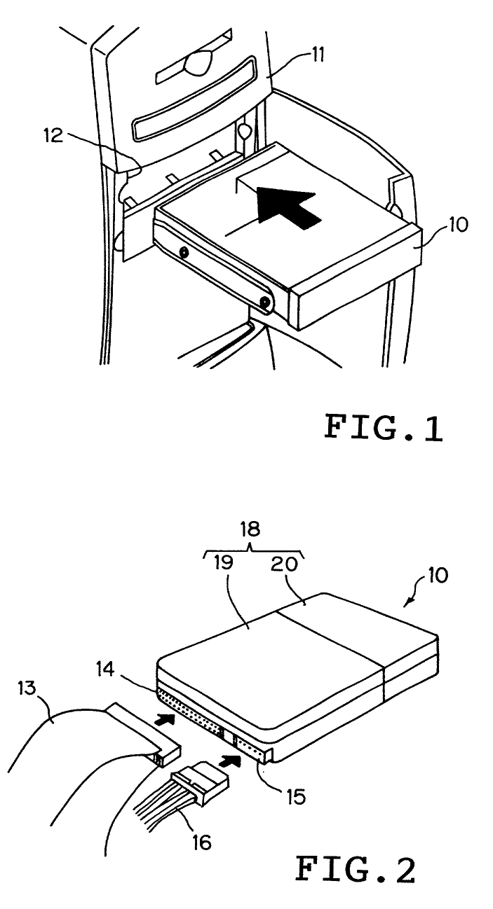

FIG. 1 illustrates a hard disk drive unit (HDD) 10 as a recording disk apparatus according to a first embodiment of the present invention. The HDD 10 is, in this case, employed in a computer system 11 such as a workstation or a personal computer. The HDD 10 may be built-in in the computer system 11 at a factory, or may be incorporated into the computer system 11 through a slot 12 after the completion of assembly as shown in FIG. 1. Otherwise, the HDD 10 may be used as an exterior storage means. The computer system 11 can be a mobile notebook type or portable type.

Referring to FIG. 2, the HDD 10 comprises a first connector 14 which receives a control cable 13 extending from a main board, not shown, in the computer system 11. The HDD 10 communicates with the computer system 11 by using electric signals transferred in the control cable 13 and received by the first connector 14 for control.

The HDD 10 is provided with electric power from a power supply cable 16 connected to a second connector 15 for power supply. The power supply cable 16 leads to a power supply unit, not shown, in the computer system 11.

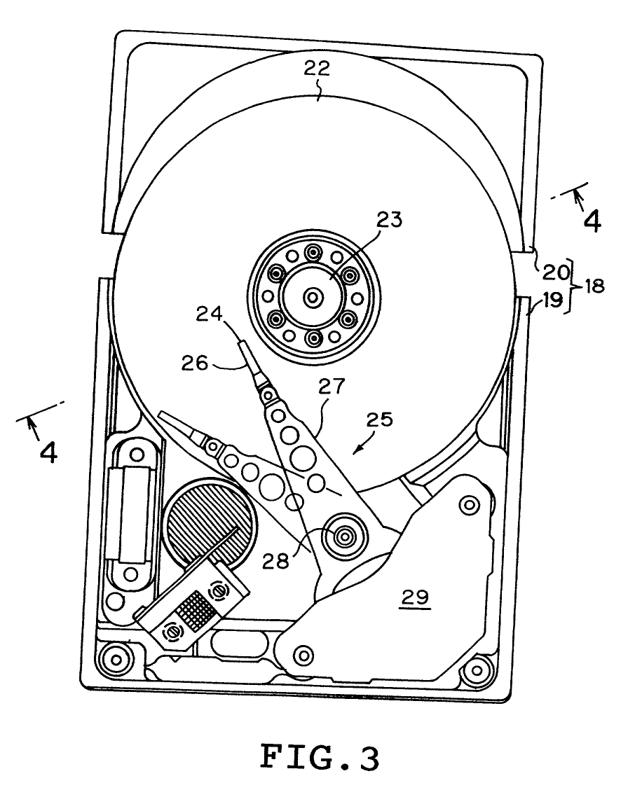

A housing 18 of the HDD 10 comprises a first and a second half shell 19, 20. As shown in FIG. 3, a rotation axis 23 for a magnetic disk 22 is attached to the first half shell 19. When the second half shell 20 is coupled to the first half shell 19, the magnetic disk 22 exposing out of the first half shell 19 is covered by the second half shell 20. In this way, the whole magnetic disk 22 is accommodated in the space formed by the coupled first and second half shells 19, 20.

A magnetic head 24 is opposed to the disk face of the magnetic disk 22. The magnetic head 24 can be driven for swinging movement in the radial direction of the magnetic disk 22 by the action of an actuator mechanism 25. The actuator mechanism 25 comprises a carriage arm 27 supporting at its tip end the magnetic head 24 via a suspension 26 such as a plate spring. The carriage arm 27 is allowed to swing about a swinging axis 28. The swinging movement of the carriage arm 27 is driven by a magnetic circuit 29.

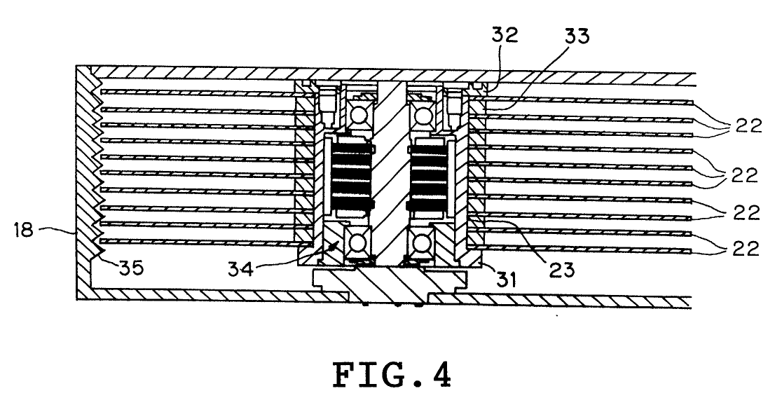

As is apparent from FIG. 4, ten magnetic disks 22 are mounted on the rotation axis 23. The magnetic disks 22 are clamped between a flange 31 at the base end of the rotation axis 23 and a clamp 32 fixed at the tip end of the rotation axis 23. Spacer rings 33 disposed between the magnetic disks 22 serve to provide constant intervals d(=1.84 mm for example) between respective pair of the magnetic disks 22 in the direction of the rotation axis 23.

The rotation axis 23 is driven for rotation by a spindle motor 34 disposed within the rotation axis 23. When the computer system 11 is intended to read out information from the magnetic disk 22, a control signal is supplied to the HDD 10 via the first connector 14. The magnetic head 24 is positioned by the tracking control using the actuator mechanism 25, and then reads out information from the rotating magnetic disk 22. When the computer system 11 is intended to record information into the magnetic disk 22, the magnetic head 24 is likewise positioned based on a control signal supplied, so that it can effect the recording operation to the rotating magnetic disk 22.

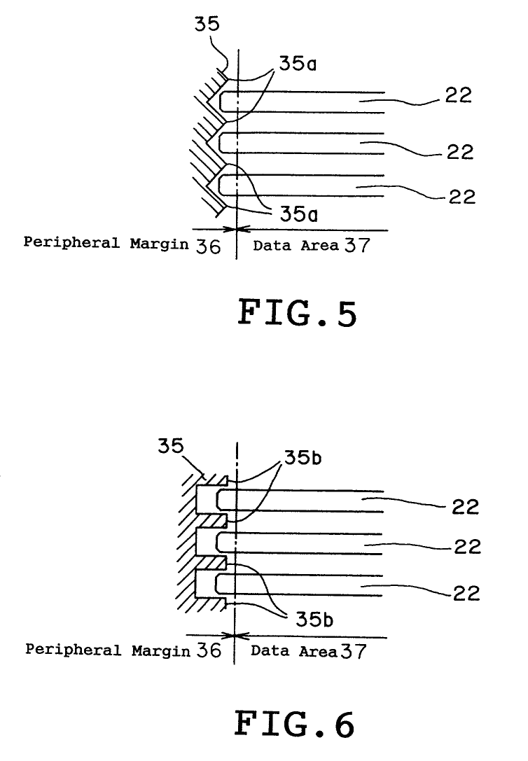

A displacement suppression piece 35 is integrally formed on the inner surface of a side wall of the housing 18. The displacement suppression piece 35 is opposed to the respective disk faces of the magnetic disks 22 with a predetermined gap. As is apparent from FIG. 5, each of protrusions 35a of triangular section on the displacement suppression piece 35 stays within the extent of the peripheral margin 36 which remains unrecorded at the outer periphery of the disk face, and fails to extend its tip end within the data area 37 for recording data on the disk face.

The description will next be made on production of the HDD 10. First, the first and second half shells 19, 20 are prepared by molding aluminum and the like. In forming the first half shell 19, the displacement suppression piece 35 is integrally formed on the side wall of the housing 18 as shown in FIG. 4. The actuator mechanism 25 with the magnetic heads 24 and other components are then mounted in the first half shell 19 as shown in FIG. 3. If the first half shell 19 can be divided into a body and a cover, the actuator mechanism 25 may easily be incorporated into the first half shell 19.

The magnetic disks 22 are inserted into an opening defined in the first half shell 19. The spindle motor 34 is then fixed to the first half shell 19. If the magnetic disks 22 are horizontally moved along the disk face, it is possible to insert the magnetic disks 22 into the first half shell 19 without interference between the magnetic disks 22 and the displacement suppression piece 35. Finally, the second half shell 20 is coupled to the first half shell 19. The first and second half shells 19, 20 are fixed to each other by screws, for example.

The displacement suppression piece 35 may be formed on the second half shell 20. In this case, after the magnetic disks 22 are inserted into the first half shell 19, the second half shell 20 may be coupled to the first half shell 19, taking care of interference between the displacement suppression piece 35 and the magnetic disks 22.

Assume that the HDD 10 is subjected to an impact outside the housing 18. The impact is supposed to act a force to invite deformation of the magnetic disk 22 with a fulcrum at the inner end where the magnetic disk 22 is coupled to the rotation axis 23, as is apparent from FIG. 4. The deformation is expected to cause more displacement toward the outer periphery of the magnetic disk 22.

As is apparent from FIG. 5, the outer periphery of the magnetic disk 22 without support or restraint is supposed to displace by a predetermined amount defined by the gap between the displacement suppression piece 35 and the magnetic disk 22. The outer periphery thereafter interferes with the protrusion 35a on the displacement suppression piece 35, so that further displacement can be prevented. As a result, deformation of the magnetic disks 22 are suppressed so that less impact is transmitted to the magnetic heads 24 and the suspensions 26.

At the same time, the carriage arm 27 of higher rigidity is prevented from interfering with the magnetic disks 22 since the larger deformation of the magnetic disks 22 are prevented. Damage to the magnetic disks 22 can be avoided. Moreover, the magnetic disks 22 interferes with the protrusions 35a at the peripheral margin 36 where no data is recorded, so that no damage can be effected on the data area 37 or recorded data. Excellent writing and reading operation of the magnetic head 24 can be insured.

The gap between the periphery of the magnetic disk 22 and the protrusion 35a, which defines displacement amount of the periphery of the magnetic disk 22, may be determined in consideration of a spring coefficient of the suspension 26, distance between the disk face of the magnetic disk 22 and the tip end of the carriage arm 27, and the like. And also, the protrusions 35a on the displacement suppression piece 35 can be disposed all or partially around the periphery of the magnetic disk 22. However, the protrusions 35a are preferably positioned at the extension of the trace for the movement of the magnetic head 24, so as to minimize the displacement of the magnetic disk 22 along the trace of the magnetic head 24. Furthermore, protrusions 35b of rectangular section may be employed in the displacement suppression piece 35, as shown in FIG. 6, in place of the protrusions 35a of triangular section.

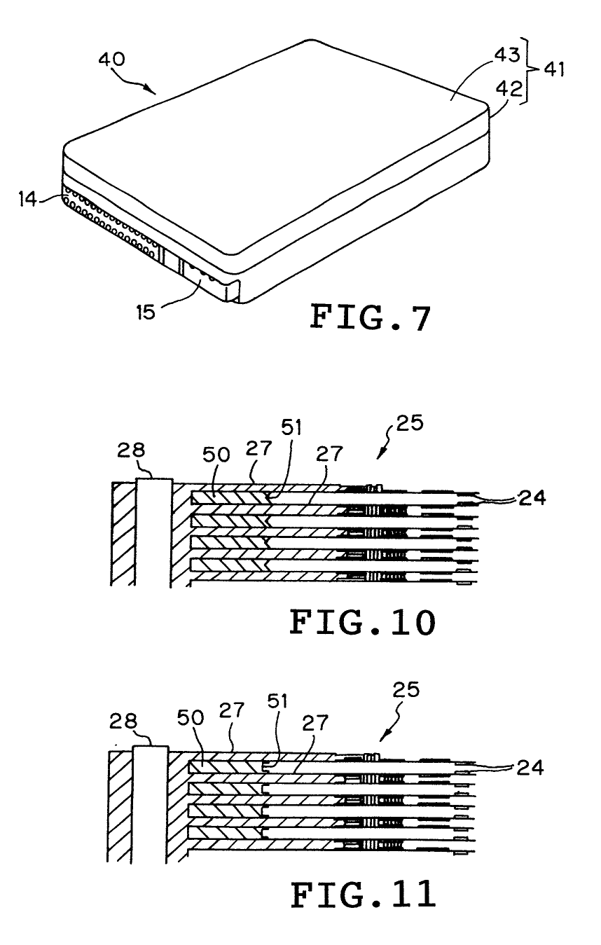

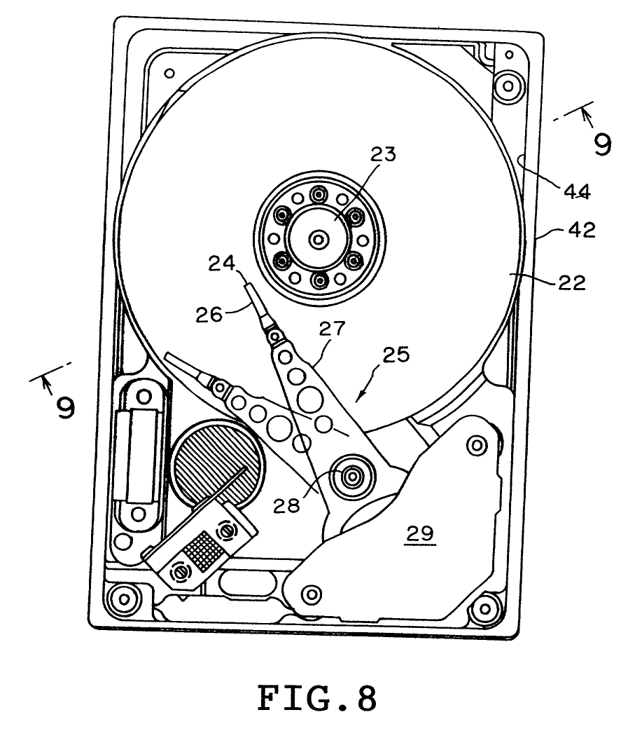

FIG. 7 illustrates an HDD 40 according to a second embodiment of the present invention. A housing 41 of the HDD 40 comprises a housing body 42 and a cover 43. As shown in FIG. 8, the magnetic disk 22, the actuator mechanism 25, and other components are mounted on the housing body 42 through an opening 44 defined in the housing body 42. When the cover 43 closes the opening 44, the magnetic disks 22 and the other components for the HDD 40 can be accommodated in the housing 41. It should be noted that the identical reference numerals are attached to the structure achieving the same effect or function as of the aforementioned first embodiment, detailed description thereof is omitted.

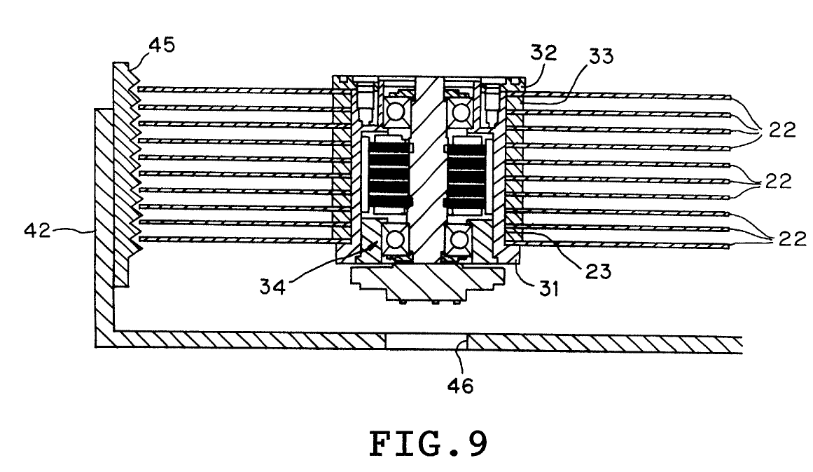

A displacement suppression piece 45 is formed independent from the housing 41 in this second embodiment as shown in FIG. 9. Accordingly, the magnetic disks 22 can be mounted on the housing body 42 without interference with the displacement suppression piece 45 in assembling the HDD 40, if the spindle motor 34 is assembled into an attachment bore 46 of the housing body 42 with the displacement suppression piece 45 kept constant away from the magnetic disks 22. The displacement suppression piece 45 may be attached to the inner surface of the housing 41 with an adhesive or the like, or may be clamped between the housing body 42 and the cover 43. The displacement suppression piece 45 fixed on the inner surface of the housing 41 may achieve advantages in the same manner as the displacement suppression piece 35 in the aforementioned first embodiment. Moreover, if the displacement suppression piece 45 has an elasticity, the magnetic disk 22 can be prevented from damages upon interference with the displacement suppression piece 45.

In case the housing 41 comprises the cover 43 and the housing body 43 as described above, a displacement suppression piece 50 may be assembled into the actuator mechanism 25, as shown in FIG. 10. The displacement suppression piece 50 may be located between the carriage arms 27.

A groove 51 is formed at the tip end of the displacement suppression piece 50 for receiving the periphery of the magnetic disk 22 with a gap. The surface of the groove 51 is designed to be opposed to the disk faces of the magnetic disk 22. The displacement suppression piece 50 may achieve advantages in the same manner as the aforementioned displacement suppression piece 35.

In general, relative position of the actuator mechanism 25 and the magnetic disk 22 is kept fixed so as to assemble the actuator mechanism 25 and the magnetic disk 22 into the housing body 42 at the same time in assembling the HDD 40. Accordingly, the displacement suppression piece 50 can be positioned without a positioning mechanism specific to the displacement suppression piece 50, different from the aforementioned displacement suppression piece 45 requiring a specific positioning mechanism. The groove 51 in the displacement suppression piece 50 can take a triangular section as shown in FIG. 10, or a rectangular section as shown in FIG. 11.

What is claimed is:

1. A recording disk apparatus comprising a displacement suppression piece opposed to a recording disk.

2. The recording disk apparatus according to claim 1, wherein said displacement suppression piece is opposed to a peripheral margin on the recording disk.

3. The recording disk apparatus according to claim 1, wherein said displacement suppression piece is integrally formed on a housing which accommodates at least the recording disk.

4. The recording disk apparatus according to claim 1, wherein said displacement suppress ion piece is assembled in an actuator mechanism for driving a head opposed to the recording disk.

5. The recording disk apparatus according to claim 1, said displacement suppression piece is opposed to a peripheral surface of the recording disk.

6. A displacement suppression piece for a recording disk apparatus, attached to a housing for at least a recording disk so as to be opposed to the recording disk.

7. The displacement suppression piece according to claim 6, wherein said piece is opposed to a peripheral margin on the recording disk.

8. An actuator mechanism for a recording disk apparatus, comprising:
an arm supported for swinging movement to bear a head opposed to a recording disk; and
a displacement suppression piece attached to the arm so as to be opposed to the recording disk.

9. The actuator mechanism according to claim 8, wherein said displacement suppression piece is opposed to a peripheral margin on the recording disk.
